(19) United States
(12) Patent Application Publication
(10) Pub. No.: US 2026/0036487 A1
(43) Pub. Date: Feb. 5, 2026

(54) LEAKAGE DETECTION APPARATUS AND METHOD FOR DETECTING PIPETTE LEAKAGE

(71) Applicant: Almond Designs, Inc., Walnut, CA (US)

(72) Inventors: Felix Hau Fai YIU, Walnut, CA (US); William James SCHOOLS, Sun City West, AZ (US)

(21) Appl. No.: 18/789,464

(22) Filed: Jul. 30, 2024

(51) Int. Cl. G01M 3/38; B01L 3/02

(52) U.S. Cl. CPC G01M 3/38; B01L 3/0213

(57) ABSTRACT

Aspects of the present disclosure provide a novel design of a pipetting leakage detection apparatus that addresses the shortcomings of the current art for full-time leakage detection for pipetting actions using a single channel pipettor or multichannel pipettors. The pipetting apparatus employs an image capturing device combined with an image analysis process to provide a reliable and comprehensive leakage check for each channel of a multichannel pipettor.

### TECHNICAL FIELD

The technology discussed below relates generally to a leakage detecting apparatus, and more particularly, to an apparatus and a method for detecting leakage of a pipetting apparatus.

### INTRODUCTION

The present disclosure relates to the field of small volume liquid pipetting using the air displacement pipetting technique. Air displacement pipettors can be used to pipette small volumes of liquid (also described as to aspirate and dispense liquid), a typical volume range being 1 microliter to 5 milliliters of liquid.

The air displacement pipettor is based on a well-established design that uses a moving piston within a cylinder which may be machined, injection-molded, or similarly constructed. This cylinder is attached to a pipettor tip (tip) which can be submersed into a liquid container. When the piston is withdrawn away from the tip, it creates a partial vacuum (or lower pressure) within the cylinder chamber which will cause the liquid to rise into the tip due to ideal gas laws. This is referred as the aspiration step. The tip can then be moved out of the liquid container, and the liquid will remain within the tip without falling out due to the partial vacuum within the cylinder chamber above the tip. After the aspiration step, the tip can be lifted from the source liquid container and moved to another location such as a destination container while retaining the liquid in the tip. When the tip is in position over the destination container, the piston can then be moved downward toward the tip which will cause an increase in pressure in the air column between the piston and the liquid inside the tip. This increased pressure will then cause the liquid to be dispensed from the tip into the destination container.

A common method for containing the liquid is to use a disposable pipette tip to hold the liquid after it is aspirated and before it is dispensed. A common material used for the pipette tips is polypropylene. The advantage of a disposable pipette tip in comparison to a reusable fixed tip is that the liquid being pipetted only comes into contact with the disposable tip, which is discarded after each use thus preventing any carryover or sample-to-sample contamination in between pipetting operations. Reusable fixed tips must be washed in between each pipetting operation, and even the washing protocol does not guarantee complete elimination of carryover. Therefore, the use of disposable pipette tips is very common in various applications.

Air displacement pipettors can be configured to pipette one liquid sample at a time, or more than one at the same time via parallel operation. When more than one sample is pipetted at the same time, a multichannel pipettor is commonly used. A multichannel pipettor has one disposable tip loaded for each channel. Multichannel pipettors can have a range of channel numbers, typical examples being from 8 tips, 96 tips and up to 384 in arrays of 1×8, 8×12, and 16×24 respectively, being used in parallel.

Whether a single channel or multichannel pipettor is used, it is a requirement that there is an airtight seal for the entire pipetting mechanism, otherwise the integrity of the partial vacuum used for pipetting will be compromised, which then will cause variability or error in the actual volume aspirated and then dispensed. This will then lead to undesired errors in the scientific results due to the pipetting error. This condition is difficult to diagnose as such potential leakage in the air tightness can be very small and is not readily observable.

In some examples, leakage can occur in a pipettor in a variety of locations within the pipetting channel, for example around scaling o-rings for the moving piston. However the most common location for leakage is at the interface of the disposable tip where it is mechanically attached to the piston channel. The method of attaching the disposable tip varies, but a common method uses a machined metal or plastic extension (which may be referred to as a “bullet” or “cone”) that is designed to accept the top part of the pipette tip. The pipette tip is then pushed onto this extension using some degree of force which will allow the more elastic pipette tip to deform slightly onto the harder metal extension, thus forming an airtight seal. This airtight seal can be compromised for any particular tip due to various reasons, including but not limited to a misaligned (or crooked) tip placement, a variation in the loading force, a dimensional variability of the tip, or a contaminant between the tip and the extension.

If a pipette tip has a failure and does not provide a solid and reliable seal, this can still allow some liquid to be pipetted. However, the actual amount that is pipetted may be less than the selected or programmed amount. This will result in an error for that portion of the scientific experiment. If the failure is not detected immediately then it will be difficult or impossible to determine the source of the error, or in the worst-case scenario the error might not be noticed which will potentially invalidate the results of the scientific experiment. If a multichannel pipettor is being used, the failure of a single tip among all of the channels being used can similarly adversely affect the results of the experiment.

In some cases, a human operator of the pipettor can visually inspect the tips before the pipetting process is completed, and confirm that liquid has been properly aspirated for all tips being used in a multichannel pipettor. However, this is not a practical solution for various reasons. It would require constant attention by the human operator and many pipettors operate repeatedly in an automated fashion for extended periods of time. Also, it is difficult for a human operator to clearly see all of the tips of a multichannel pipettor. For example, a 96 channel liquid handling head configured in an 8×12 grid array is very tightly spaced, and the spatial position within the liquid handler is often not easily viewable by the operator. For example, a 384 channel liquid handling head configured in a 16×24 grid within the same dimensional footprint is even more densely packed with tips, making it nearly impossible to view all 384 tips. For these reasons, it is impractical for the human operator to confirm reliable aspiration for every experimental step, and in practice this is not typically done.

Current technologies are available for leak detection which employ a pressure or vacuum-based apparatus to monitor the integrity of the seal. These methods require extra time to check for leaks, reducing the practicality of leak detection monitoring for every pipetting action. They are also difficult or impossible to use with multichannel pipettors. Therefore, it is desirable to have a leak detection system or method that can check the integrity of every pipetting action as it occurs so that a high degree of confidence in the accuracy of the pipetted volume can be achieved for high numbers of liquid transfers, in combination with an automatic system that does not require extra time and effort from the operator.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

Aspects of the present disclosure provide a novel design of a pipetting leakage detection apparatus that addresses the shortcomings of the current art for full-time leakage detection for pipetting actions using a single channel pipettor or multichannel pipettors. The pipetting apparatus employs an image capturing device combined with an image analysis process to provide a reliable and comprehensive leakage check for each channel of a multichannel pipettor.

One aspect of the disclosure provides a reliable and convenient method of performing a pipettor leak check for every instance of pipetting when using an automated multichannel pipetting system, therefore providing a high degree of confidence in the pipetting results for every liquid handling or pipetting operation.

One aspect of the disclosure provides a leak detection method using high resolution image processing to confirm the proper operation without leaks for a multichannel pipetting system.

One aspect of the disclosure provides a process that automatically pauses an automated multichannel pipettor in case of a leak test failure.

One aspect of the disclosure provides to a pipette leak detection method that is compatible with any available brand or model of automated multichannel pipettor or liquid handling system.

One aspect of the disclosure provides a camera-nest combo that can be installed on the deck of an automated multichannel pipettor. When the camera is not used, the camera/nest position to be used for other purposes, thus saving space.

One aspect of the disclosure provides a leakage detection apparatus including an image capturing device configured to capture an image of at least one pipette tip. The leakage detection apparatus further includes a processor configured to capture, using the image capturing device, an image of the at least one pipette tip. The processor is further configured to detect a leakage of the at least one pipette tip based on the image.

One aspect of the disclosure provides a method of operating a leakage detection apparatus. The method manipulates at least one pipette tip to aspire a liquid. The method further dispenses a portion of the liquid from the at the least one pipette tip. The method further captures an image of the at least one pipette tip. The method further detects a leakage of the at least one pipette tip based on the image.

One aspect of the disclosure provides a leakage detection apparatus. The apparatus includes means for dispensing a portion of a liquid from at least one pipette tip. The apparatus further includes means for capturing an image of the at least one pipette tip. The apparatus further includes means for detecting a leakage of the at least one pipette tip based on the image.

These and other aspects will become more fully understood upon a review of the detailed description, which follows. Other aspects, features, and examples will become apparent to those of ordinary skill in the art upon reviewing the following description of specific exemplary aspects in conjunction with the accompanying figures. While features may be discussed relative to certain examples and figures below, all examples can include one or more of the features discussed herein. In other words, while one or more examples may be discussed as having certain features, one or more of such features may also be used in accordance with the various examples discussed herein. Similarly, while examples may be discussed below as device, system, or method examples, it should be understood that such examples can be implemented in various devices, systems, and methods.

### BRIEF DESCRIPTION OF THE DRAWINGS

FIG. 1 is a flow chart that shows an exemplary procedure for detecting a leakage in a pipetting apparatus according to some aspects of the disclosure.

FIG. 2 illustrates an exemplary pipetting apparatus with a leak detection function according to some aspects of the disclosure.

FIG. 3 illustrates the pipetting apparatus with a pipetting head loaded with disposable pipette tips.

FIG. 4 illustrates the pipetting apparatus with the pipetting head moved into a position over a source liquid reservoir.

FIG. 5 illustrates the pipetting apparatus with the pipette tips lowered into a source liquid to aspirate the liquid into the pipette tips.

FIG. 6 illustrates the pipetting apparatus with the pipetting head moved into a position over a leak checking device.

FIG. 7 illustrates a view from the bottom of the pipetting head with disposable tips as seen by the leak checking device.

FIG. 8 illustrates the pipetting apparatus after the pipetting head controlled to deliver a small amount of liquid from the pipette tips.

FIG. 9 illustrates a view from the bottom of the pipetting head with droplets of liquid at the tips.

FIG. 10 illustrates the view of FIG. 9 with one droplet missing on one of tips.

FIG. 11 illustrates the pipetting apparatus of with the pipetting head moved into a position over a destination plate.

FIG. 12 illustrates the pipetting apparatus with the pipetting head lowered to the destination plate for a final liquid delivery.

FIG. 13 illustrates a block diagram of a processing system of the pipetting apparatus according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using hardware, computer software, firmware, or any combination thereof. Whether such elements are implemented as hardware or software depends upon the particular application and design constraints imposed on the overall system.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements.

In the following discussion that addresses a number of embodiments and applications of the present invention, reference is made to the accompanying drawings that form a part hereof, and in which is shown by way of illustration specific embodiments in which the invention may be practiced. This invention may, however, be embodied in other forms and should not be construed as limited to the embodiments set forth herein. Instead, these embodiments are provided by way of illustration only and so that this disclosure will be thorough, complete and will fully convey the full scope of the invention to those skilled in the art.

Aspects of the present disclosure provide a novel design of a leakage detection apparatus. In some aspects, the leakage detection apparatus can provide full-time leakage detection for pipetting actions using a single channel or multichannel pipettor. The leakage detection apparatus employs an image capturing device combined with image processing to provide a reliable and comprehensive leakage check for every channel of a multichannel pipettor.

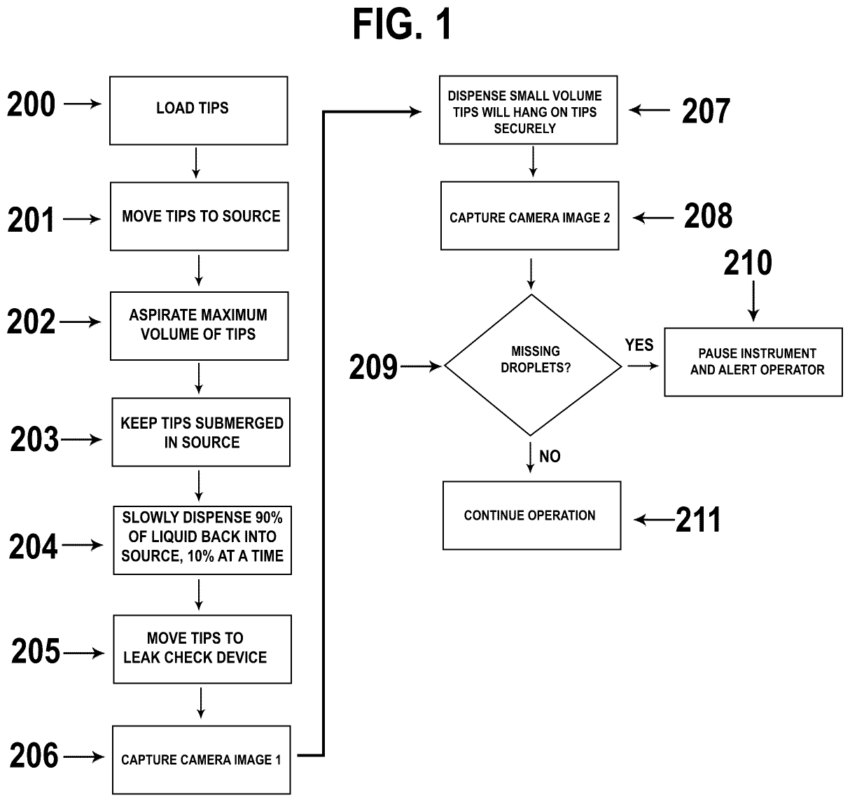

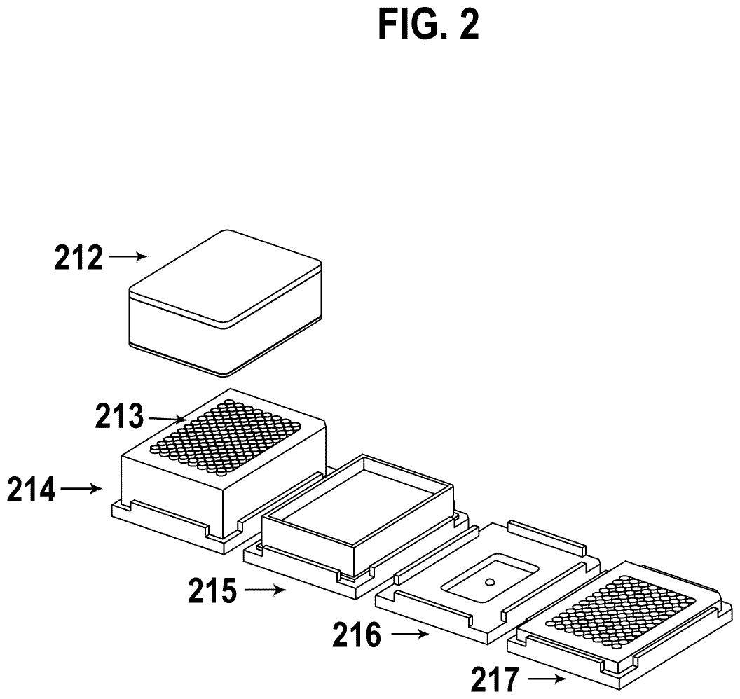

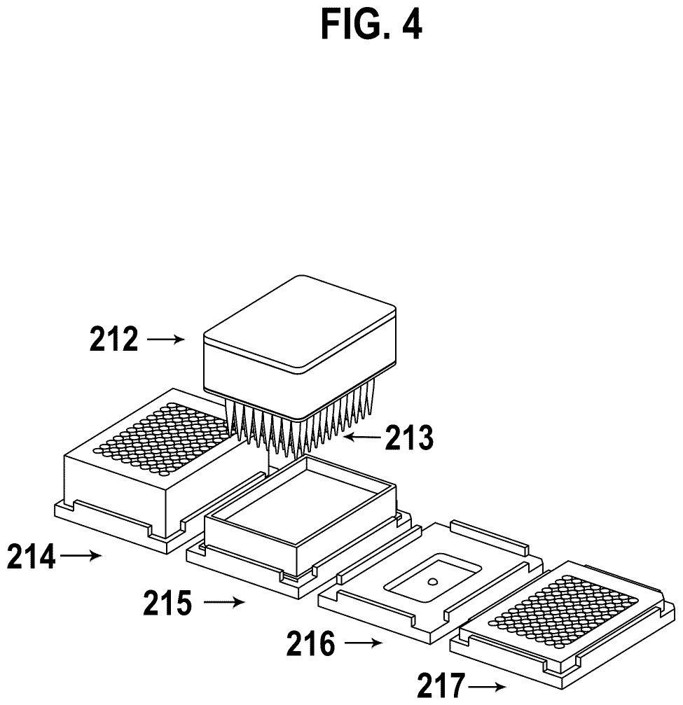

FIG. 1 is a flow chart illustrating an exemplary procedure of detecting a leakage of a pipetting apparatus according to some aspects. In some aspect, the leakage detection procedure can be implemented using a combination of software and the hardware. The software and hardware can interface with each other to provide the capabilities to implement the leakage detection function. The leakage detection procedure is described below in more detail with reference to an exemplary pipetting apparatus shown in FIGS. 2-13. In some aspects, the pipetting apparatus includes a multichannel pipetting head 212 shown in the drawings along with disposable pipette tips 213 held in a rack 214, a liquid reservoir 215, a leak checking device 216, and a destination container 217 for the pipetting of the liquid.

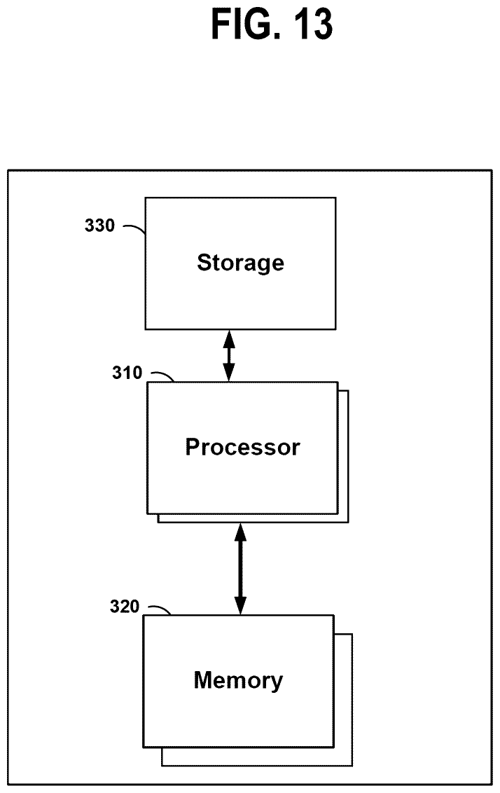

The pipetting apparatus may include a processing system for controlling the apparatus to perform various functions described below. FIG. 13 illustrates an exemplary processing system 300 according to some aspects of the disclosure. The processing system may include one or more processors 310 and memory 320, and may be controlled by an operating system that is loaded from internal or external storage as data and instructions that are executable by the processor. The processing system may further include a local storage 330, which can be used to maintain operational parameters and other information (e.g., database, images) used to configure and operate the apparatus. The local storage 330 may be implemented in flash memory, magnetic media, non-volatile or persistent storage, optical media, tape, soft or hard disk, or the like.

At block 200 of FIG. 1, the apparatus can load the pipette tips onto the pipetting head. FIGS. 2-13 illustrate various components of an exemplary pipetting apparatus according to some aspects of the disclosure. The pipetting apparatus can be a part of a multichannel liquid handling system. In one example, the liquid handling head 212 can have multiple channels (e.g., internally 96 pipetting channels in an 8×12 array). In other examples, the apparatus can have any other multichannel configurations. For liquid handling operations, the disposable pipette tips 213 are loaded onto the bullets (not shown) of the liquid handling head 221. Initially, the pipette tips 213 can be placed in a rack 214 which contains the tips (e.g., 96 disposable tips loaded in the 8×12 array). In FIG. 2, the liquid handling head 212 is shown in a position prior to the loading of the tips 213.

The liquid to be transferred by the tips is stored in a liquid reservoir 215. For example, the liquid reservoir can be a trough-like design as shown, or any other suitable type of storage reservoir that can be accessed by the liquid handling head and the tip. The liquid reservoir 215 can be located on a position on the deck of a liquid handler. In some aspects, the pipette apparatus can use a single or multiple liquid reservoirs. The disclosed pipetting apparatus shown in FIGS. 2-13 can be designed or adapted to work with one or more liquid reservoirs.

The pipetting apparatus further includes a leak check device 216, for example, a camera-plate combo or an image capturing device. The lead check device 216 can be located on a position of the deck of the liquid handler and includes a camera. In some examples, the image capturing device may include one or multiple lenses. When the leak checking function is not used, the location of the leak check device can be used as a nest for an additional labware.

After the liquid is aspirated into the pipette tips, the tips containing the liquid are moved over to another deck position on the liquid handler, for example, a destination container 217. The liquid can then be dispensed into this destination container by the pistons in the liquid handling head 212. The destination container 217 may be a multichannel receptacle such as a 96 well microplate as shown in the drawing, or any other type of labware that is capable of accepting the dispensed liquid.

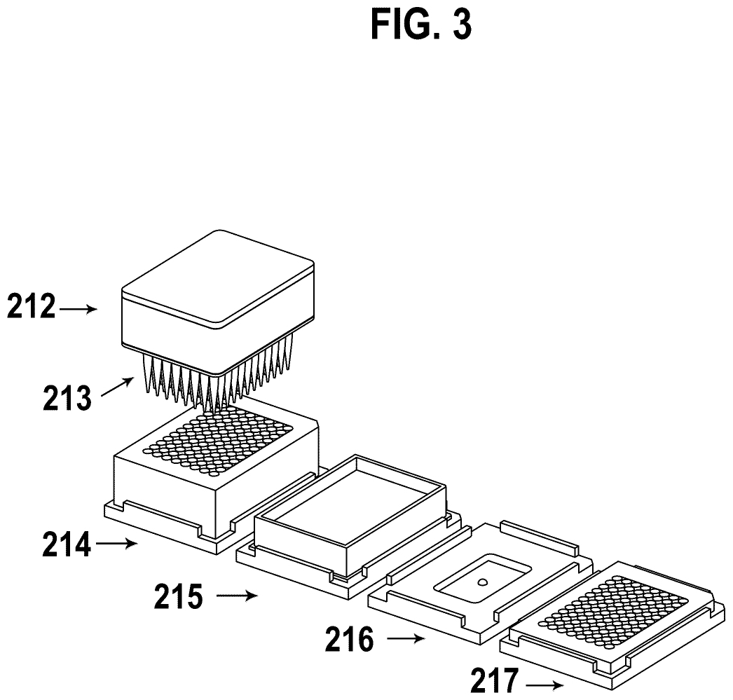

FIG. 3 shows the next step after loading the pipette tips 213. The liquid head 212 is now shown with the pipette tips 213 loaded into position. This can be accomplished using the pipetting apparatus's built-in loading mechanism to load the pipette tips. The tip loading process can be accomplished in different ways, and the scope of this disclosure can apply to any of these different methods of loading the pipette tips.

At block 201 of FIG. 1, the liquid handling process moves the tips 213 to the liquid source. For example, after the disposable tips 213 are loaded onto the liquid handling head 212, the multichannel pipetting system can then position the disposable tips 213 over the liquid reservoir 215. This can be accomplished by moving the liquid handling head 212 or by moving the deck holding the liquid reservoir 215. The invention is designed to work the same or similar way with any varying configurations of an automated liquid handling pipettor.

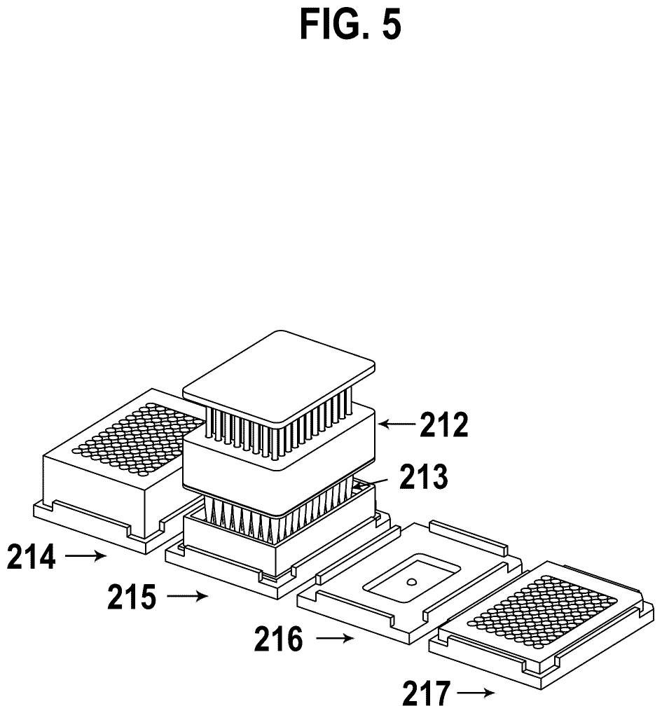

At block 202 of FIG. 1, the pipetting apparatus can manipulate the tips to aspirate the maximum (or predetermined) volume of liquid. For example, in FIG. 5, the liquid handling head 212 has been placed into position such that the disposable tips 213 can be lowered into the liquid of the liquid reservoir 215. For example, this operation can be accomplished by lowering the liquid handling head 212 or by raising the liquid reservoir 215. In this position, the liquid handling head 212 is able to aspirate the desired volume of liquid into the disposable tips 213. For example, this operation can be accomplished by mechanically raising the pistons (e.g., 96 pistons) that are part of the liquid handling head design 212.

At block 203 of FIG. 1, the pipetting apparatus keeps the tips submersed in the liquid (see FIG. 5). At block 204 of FIG. 1, while the tips are submerged, the pipetting apparatus can slowly dispense 90% of the aspirated liquid back into the liquid reservoir 215 in multiple steps, for example, 9 steps of 10% at a time. This will leave 10% of the original aspirated volume within the disposable tips 213 for testing. In other examples, the pipetting apparatus can dispense any desirable amount of the liquid back into the liquid reservoir 215 using one more steps.

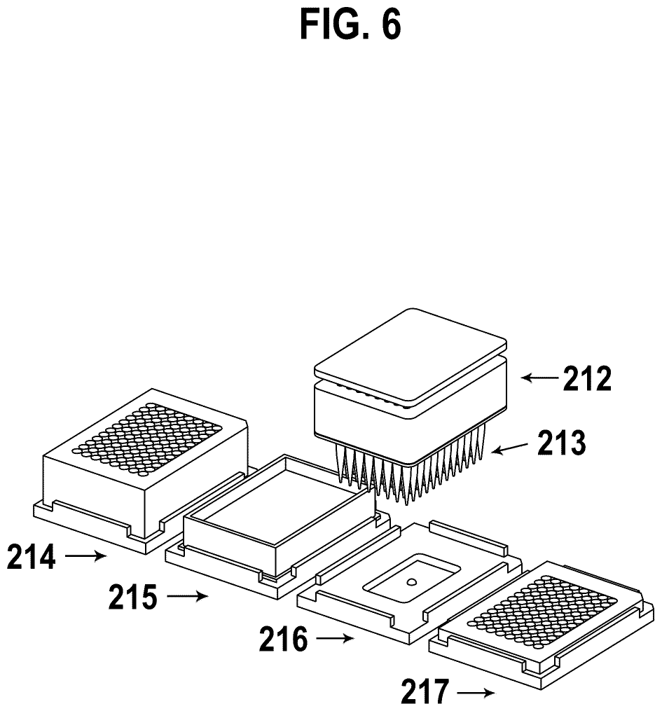

At block 205 of FIG. 1, the pipetting apparatus moves the liquid handling head 212 to a position over the leak check device 216 (see FIG. 6). The disposable tips 213 now contain the liquid that has aspirated as described in relation to FIG. 5.

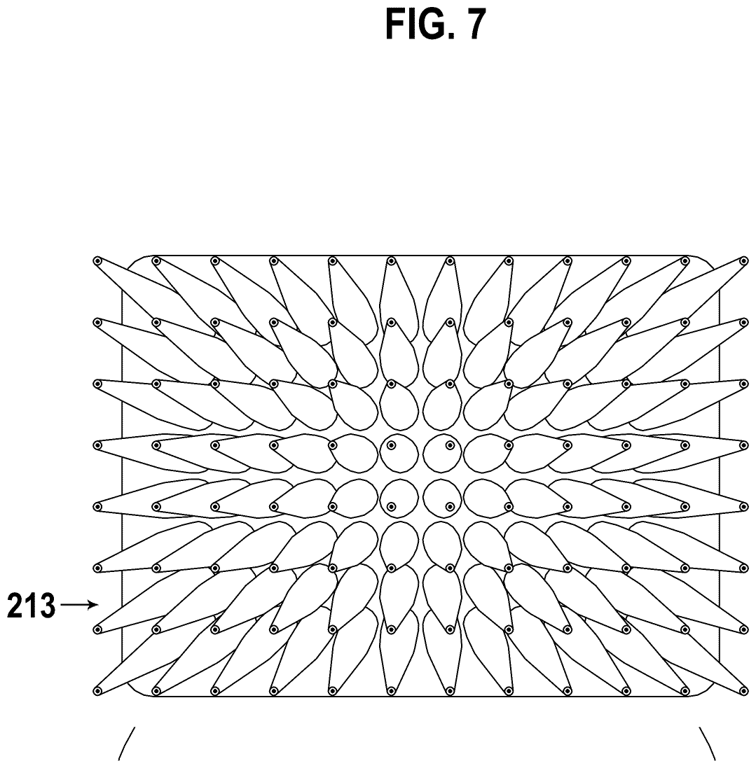

At block 206 of FIG. 1, with the liquid handling head 212 and the disposable tips 213 in the position over the leak check device 216, the pipetting apparatus can capture an image (image 1) using an image capturing device (e.g., camera) and store the image for further processing, for example, using the processing system 300 of FIG. 13. FIG. 7 shows an exemplary representation of how this image can appear, for example, showing all 96 of the disposable tips 213 from a bottom viewpoint.

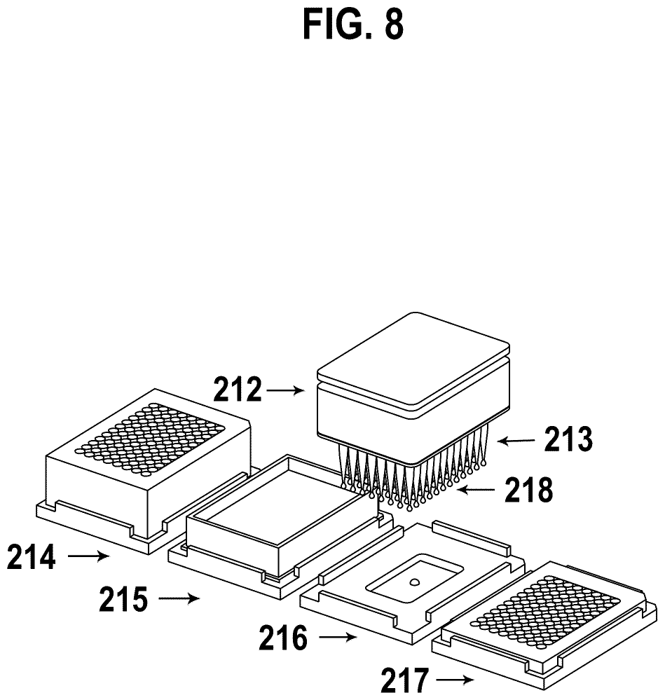

At block 207 of FIG. 1, the pipetting apparatus can control the liquid handling head 212 to dispense a small volume of liquid. In some examples, the volume can be in the range of 1 to 10 microliters. As shown in FIG. 8, this operation can cause a small droplet 218 to form at the bottom of each disposable tip 213. In normal operating condition, these droplets 218 will remain in position suspended from the disposable tips 213, held there by a combination of the partial vacuum within the disposable tips 213 and surface tension forces.

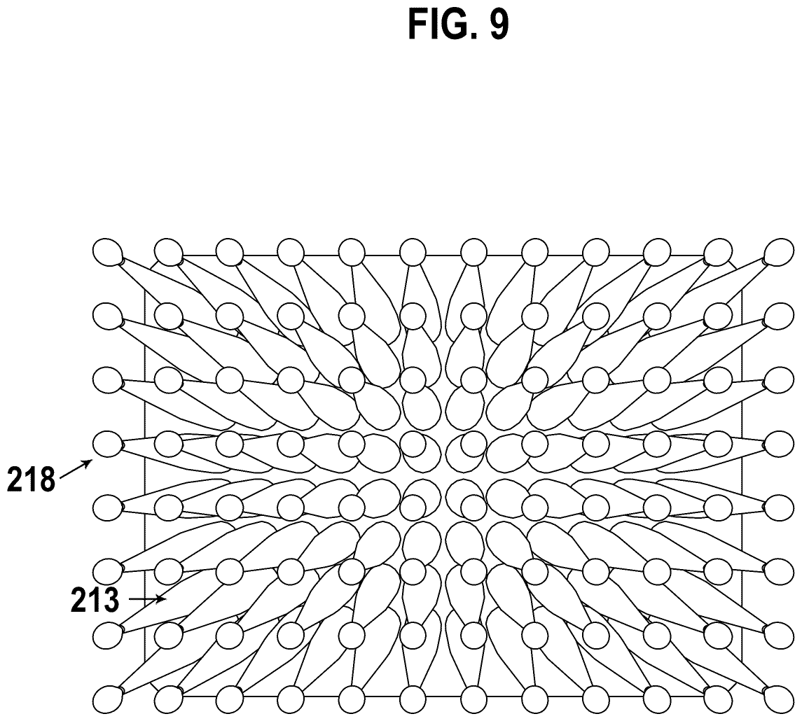

At block 208 of FIG. 1, the pipetting apparatus can take another camera image (image 2) and store the image for further processing. FIG. 9 shows an exemplary conceptual representation of how this image may appear. In this case, all disposable tips (e.g., 96 tips) are visible in the image, and each of the tips 213 has a small droplet 218 suspended from it. FIG. 9 represents the condition where all of the channels (96 in this case) are in proper working condition, that is, there are no leaks into the partial vacuum inside the tips within the pipetting mechanism or at the point of seal of the disposable tips 213 to the liquid handling head 212.

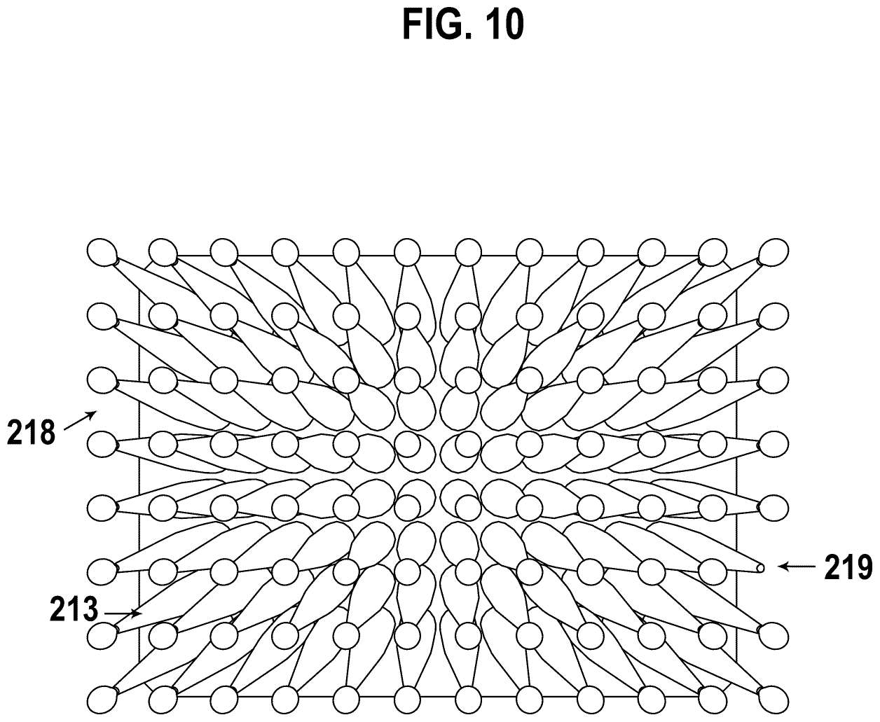

FIG. 10 shows an exemplary representation of how the camera image may appear for a failure condition of one pipetting channel. If there is an air leak located somewhere within any liquid handling channel, the result will be a missing small droplet 219 as shown in FIG. 10, which indicates a failure to properly aspirate and dispense the correct amount of liquid. This example is illustrated with one tip with a missing droplet 219. In typical ongoing pipetting operations, it is possible for any of the pipetting channels (e.g., 96 channels) to have a failure, and there can be more than one missing droplet. An aspect of the invention provides the capability to test for this condition, for example, based on the captured image and image processing software. In some aspects, for each of the image taken, a computer or the like can store the information, together with the pipetting protocol, the time and date, for tracing purpose, such that a scientist or operator can investigate when problems are found in the result of the experiments.

After the second image has been taken and stored, at block 209 of FIG. 1, the pipetting apparatus can make a decision based on the appearance of the image, for example, using suitable image processing software. If any droplets (e.g., droplet 219) are missing such as the example shown in FIG. 9, at block 210 of FIG. 1, it indicates a failure condition, and the pipetting apparatus can pause and alert the operator. Alternatively, the software can be designed in such a way that a regional pipetting error is allowed and can be recorded and then ignored so that the pipetting operation may continue. In another example, the apparatus can compare the size of each droplet to a reference. If the size of the droplet is smaller than a reference, it also indicates a failure condition of the corresponding pipette channel. If all droplets are properly recognized or detected (e.g., as shown in FIG. 9), at block 211 of FIG. 1, this is a pass condition and the pipetting apparatus can continue its normal operation.

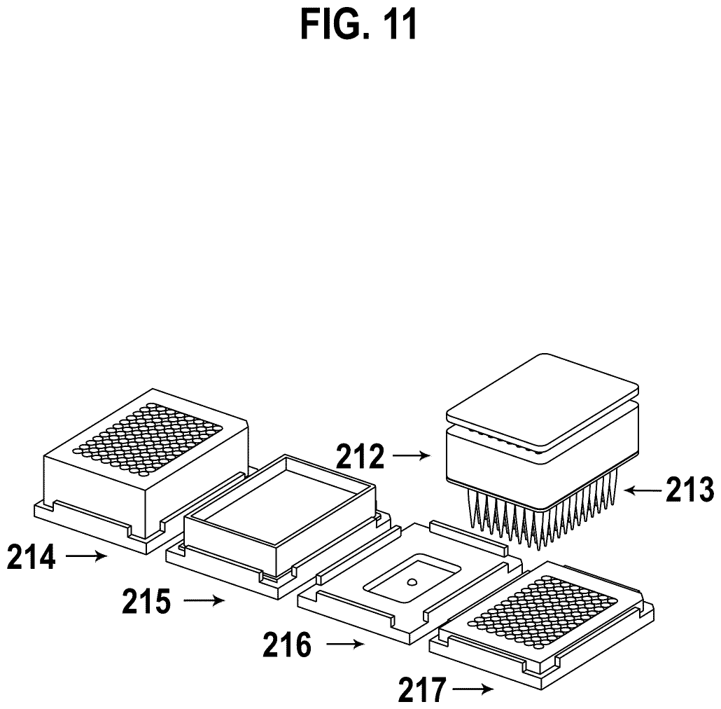

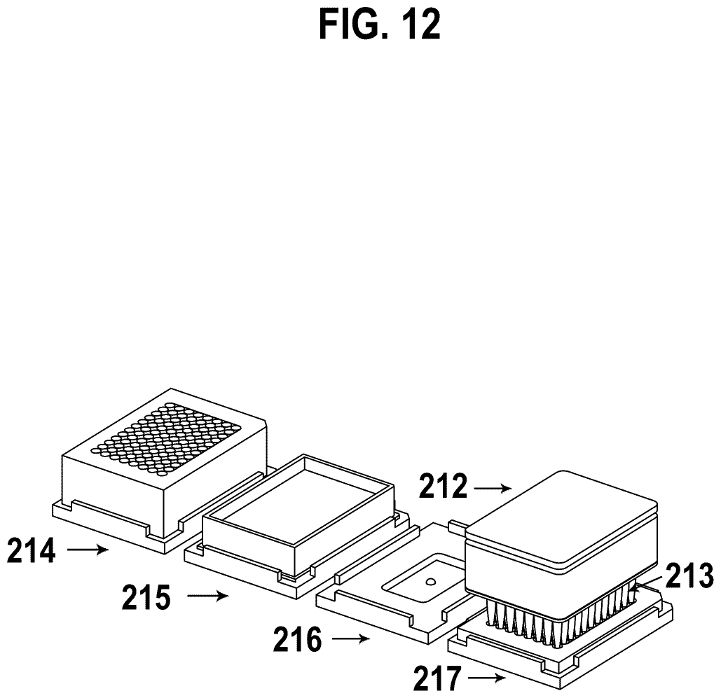

At block 211 of FIG. 1, the pipetting apparatus can continue its normal operation as shown in FIG. 11. The pipetting apparatus can position the liquid handling head 212 holding the pipette tips 213 and their stored liquid directly over the destination container 217. FIG. 12 shows the final step to complete the pipetting operation. The pipetting apparatus can place the liquid handling head 212 into a position with the disposable tips 213 placed just above the destination container 217. Then, the apparatus can control the pistons (not shown) within the liquid handling head 212 to move lower to dispense the liquid.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-13 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-13 may be configured to perform one or more of the methods, features, or steps described herein. The novel algorithms described herein may also be efficiently implemented in software and/or embedded in hardware.

Any reference to an element herein using a designation e.g., “first,” “second,” and so forth does not generally limit the quantity or order of those elements. Rather, these designations are used herein as a convenient way of distinguishing between two or more elements or instances of an element. Thus, a reference to first and second elements does not mean that only two elements can be employed, or that the first element must precede the second element.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A leakage detection apparatus comprising:
an image capturing device configured to capture an image of at least one pipette tip; and
a processor configured to:
capture, using the image capturing device, an image of the at least one pipette tip; and
detect a leakage of the at least one pipette tip based on the image.

2. The leakage detection apparatus of claim 1, wherein the processor is further configured to:
detect a presence of a droplet of a liquid at the least one pipette tip based on the image; and
determine the leakage of the at least one pipette tip based on the presence of the droplet.

3. The leakage detection apparatus of claim 2, wherein the processor is further configured to:
detect a size of a droplet of the liquid at the least one pipette tip based on the image; and
determine the leakage of the at least one pipette tip based on the size of the droplet.

4. The leakage detection apparatus of claim 2, wherein the processor is further configured to dispense a portion of the liquid to form the droplet at the at least one pipette tip.

5. The leakage detection apparatus of claim 2, wherein the processor is further configured to indicate the leakage in response to an absence of the droplet at the at least one pipette tip.

6. The leakage detection apparatus of claim 1, wherein:
the at least one pipette tip comprises a plurality of pipette tips; and
the image capturing device comprises a camera configured to capture the image that shows the plurality of pipette tips and determine a leakage of one or more of the plurality of pipette tips based on a presence or a size of a droplet of the liquid at each respective pipette tip.

7. The leakage detection apparatus of claim 1, wherein the processor is further configured to generate an alert to indicate the leakage.

8. A method of operating a leakage detection apparatus, the method comprising:
manipulating at least one pipette tip to aspire a liquid;
dispensing a portion of the liquid from the at the least one pipette tip;
capturing an image of the at least one pipette tip; and
detecting a leakage of the at least one pipette tip based on the image.

9. The method of claim 8, further comprising:
detecting a presence of a droplet of the liquid at the least one pipette tip based on the image; and
determining the leakage of the at least one pipette tip based on the presence of the droplet.

10. The method of claim 9, further comprising:
detecting a size of a droplet of the liquid at the least one pipette tip based on the image; and
determining the leakage of the at least one pipette tip based on the size of the droplet.

11. The method of claim 9, further comprising:
dispensing the portion of the liquid to form the droplet at the at least one pipette tip.

12. The method of claim 9, further comprising:
indicating the leakage in response to an absence of the droplet at the at least one pipette tip.

13. The method of claim 8, wherein:
at least one pipette tip comprises a plurality of pipette tips; and
determining a leakage of one or more of the plurality of pipette tips based on a presence or a size of a droplet of the liquid at each respective pipette tip of the plurality of pipette tips.

14. The method of claim 8, further comprising:
sending an alert to indicate the leakage.

15. A leakage detection apparatus comprising:
means for dispensing a portion of a liquid from at least one pipette tip;
means for capturing an image of the at least one pipette tip; and
means for detecting a leakage of the at least one pipette tip based on the image.

16. The leakage detection apparatus of claim 15, further comprising:
means for detecting a presence of a droplet of the liquid at the least one pipette tip based on the image; and
means for determining the leakage of the at least one pipette tip based on the presence of the droplet.

17. The leakage detection apparatus of claim 15, further comprising:
means for detecting a size of a droplet of the liquid at the least one pipette tip based on the image; and
means for determining the leakage of the at least one pipette tip based on the size of the droplet.
